(19) United States
(12) Patent Application Publication
(10) Pub. No.: US 2018/0265739 A1
(43) Pub. Date: Sep. 20, 2018

(54) Wax Coating Compositions

(71) Applicant: Dominion Chemical Company, Inc., Petersburg, VA (US)

(72) Inventors: Wilson Maclin Ferrell, JR., South Chesterfield, VA (US); William Blake Myers, Haddon Heights, NJ (US)

(73) Assignee: Dominion Chemical Company, Inc., Petersburg, VA (US)

(21) Appl. No.: 15/700,643

(22) Filed: Sep. 11, 2017

Related U.S. Application Data
(60) Provisional application No. 62/472,789, filed on Mar. 17, 2017.

(51) Int. Cl. C09D 191/06; C09D 123/08

(52) U.S. Cl. CPC C09D 191/06; C09D 123/0869; C09D 123/0853

(57) ABSTRACT

The present wax coating compositions are based on the use of n-alpha olefins instead of petroleum-based paraffin waxes otherwise currently employed. The coating composition may be used with various coating techniques, however, the compositions herein are found useful especially in curtain coating, cascading, saturating or impregnating technologies. Other coating techniques include roll coating or the use of coating or “Meyer” rods.

This application claims the benefit of U.S. Provisional Patent Application No. 62/472,789 filed Mar. 17, 2017 and entitled “Wax Coating Compositions”, which is incorporated by reference herein in its entirety.

### FIELD OF THE INVENTION

The invention relates to the use of n-alpha olefin waxes in various coating formulations, including formulations for use in curtain coating, cascade, saturating (including dipping), impregnating and roll coating applications for dry and wet process in flexible packaging. The formulations provide coatings essentially free from surface defects, with excellent water barrier properties. The coatings enhance wet strength, abrasion resistance, grease resistance, and blocking resistance. The coatings also improve the appearance of the substrate.

### BACKGROUND

Curtain coated corrugated boxes are primarily used to ship perishable food products such as poultry, seafood and some types of produce, and any other products that are shipped in a cool, moist environment. Cascade and/or saturated corrugated boxes are used to ship produce, seafood, perishable food products. All types of corrugated, curtain coated, cascade or saturated boxes can also be used for non-perishable products where the corrugated box is exposed to moisture, weather, rain or humidity. Examples include boxes for stone, landscape products, and disposable trash containers. Curtain coated boxes are also used to protect industrial products from abrasion during shipping.

Impregnating is the application of the wax coating to the medium portion of a corrugated sheet material prior to the top and bottom liner sheets being adhered to opposite sides of the medium to form the corrugated sheet material. The wax coating supplies a moderate amount of moisture resistance to prevent the corrugated sheet material that forms the boxes from becoming soft due to water pickup, therefore enhancing the wet strength of a corrugated box.

The curtain coating method for treating corrugated sheet material has been used for many years. The traditional formulations that have been used in curtain coating are blends of petroleum wax, ethylene vinyl acetate polymer, and a hydrocarbon resin to increase the adhesion of the coating mixture to the corrugated sheet material. The petroleum wax is frequently a blend of paraffin wax and microcrystalline wax. The microcrystalline wax is added to increase the flexibility of the coating to prevent cracking in areas where a corrugated sheet is bent to form a box. In the curtain coating example, the equipment used to apply the coating generates a molten “curtain” of liquid that falls onto the flat precut liner face and printed boxes that are moved under the liquid curtain on a conveyor. After the individual boxes are coated and the coating has dried, the boxes are stacked onto pallets for shipment to the point of use. The viscosity of the coating blend is critical for the formation of a thin, continuous film that will coat the box without any gaps or pin holes.

The cascade or saturating method for treating corrugated sheet material has also been used for many years. The traditional formulations that have been used are blends of petroleum wax with either polyethylene, modified polyethylene with maleic anhydride or ethylene vinyl acetate. Typically, only small amounts of additive are used in these cascade or saturating wax coating formulation. Therefore, many formulations can use the coating with no additive at all. The cascade and/or saturating method for treating corrugated boxes is a process where the wax coating is applied to saturate the corrugated by cascading the wax coating from above allowing the wax coating to cover the corrugated and travel down through the flutes, fully being absorbed into the corrugated. This coverage can also be achieved by dipping the corrugated boxes or fully submerging the boxes in the molten wax coating for a period of time

Other uses for the formulations described herein are for the coating of paper and other flexible substrates used for food items such as household waxed paper, waxed bags, butter, bread, candy, ice cream and hot foods such as hamburgers and sandwich wraps.

Recently, petroleum based waxes have seen a decline in commercial supply because of the shut down or conversions of Group I oil refineries or the discontinued use of the “Dill Chill” technology that produces wax as a coproduct or by-product of crude oil refining. Newer refining technologies eliminate the wax portion through catalytic cracking or isomerization.

### SUMMARY

Accordingly, it is an object of the present invention to overcome the foregoing problems and challenges with coating compositions. In one example, a wax coating composition for a corrugated sheet material, the coating composition comprises an n-alpha olefin wax having a melting point of from about 120 degrees F. to about 175 degrees F. and an ethylene copolymer selected from the group consisting of an ethylene vinyl acetate copolymer and an ethylene n-butyl acrylate copolymer. The wax coating composition may further include an ethylene polymer and/or a tackifier. Paraffin wax may be present in the coating composition in an amount of 50% or less of the total composition, or alternatively, the wax coating composition may include essentially no paraffin wax. The amount of n-alpha olefin in the wax coating composition may be in the range of 10-100%, or alternatively 50-100%, or still further alternatively 75-95% of the total weight of the coating composition. The n-alpha olefin may be formed of molecules contain 20 or more carbon atoms, or alternatively 26 or more carbon atoms. The n-alpha olefin may be a C30+ molecule.

### BRIEF DESCRIPTION OF THE DRAWINGS

FIG. 1 is a perspective, partial cross-sectional view of a corrugated sheet material.

FIG. 2 is a graph illustrating the comparative performance of the coating described herein as compared with a prior art coating.

FIGS. 3 and 4 are gas chromatic graphs that show the composition of the n-alpha olefin coatings that are an example of the coating described herein.

### DETAILED DESCRIPTION

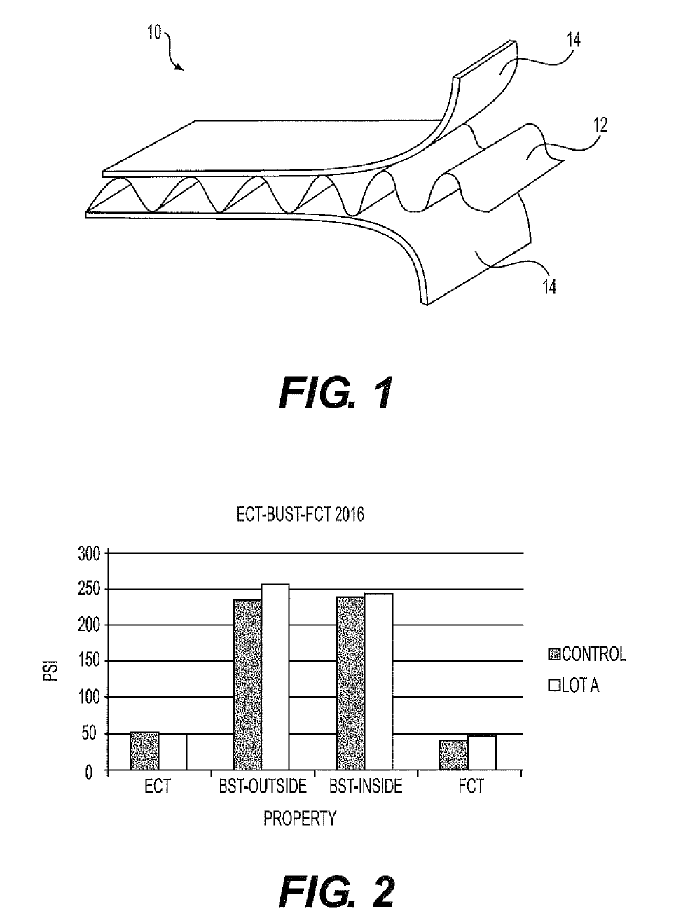

The present wax coating compositions are based on the use of n-alpha olefins instead of petroleum-based paraffin waxes otherwise currently employed in the coating of corrugated sheets typically used to make corrugated box stock. The coating composition may be used with various coating techniques, however, the compositions herein are found useful especially in curtain coating, cascading, saturating or impregnating technologies. Other coating techniques include roll coating or the use of coating or “Meyer” rods. FIG. 1 illustrates a conventional corrugated sheet material 10 with the curved medium 12 covered on opposite sides by the outer liner sheets 14. The coating techniques described herein may relate to coating of the medium portion 12 and/or the outer liners 14 of the assembled corrugated sheet material 10.

Curtain coating formulations that comprise an n-alpha olefin wax have been discovered. Previously the waxes available for making curtain coating formulations were limited to waxes manufactured from the refining process of crude oil, however, such waxes are becoming short in supply because of changes in the refining methods that yield them.

The curtain coating formulations described herein will be comprise a n-alpha olefin wax. Other functional additives or polymers may be used including one or more of a viscosity modifier, a tackifying agent, a flexibility enhancer, an anti-slip agent, an anti-oxidant and/or an additive to increase the melting temperature of the composition mixture.

The coating formulations described herein may be applied by the curtain coating equipment currently in use, including pressure head coaters and weir type coaters. Curtain coating is a process of which a molten, highly viscous thermoplastic material is applied to a substrate or article passing through a falling curtain of that material and causing a coating to be applied to the upward facing substrate or article. This same substrate can be flipped manually or with belts in order to apply a second coating to the opposing surface. The process of creating a curtain of thermoplastic material coating dictates a specific set of properties in order for the coating to be uniform, transparent, scuff resistant, water resistant and economical. In the molten state the coating must be viscous and form a continuing falling curtain without breaks or pinholes.

The formulations described herein may also be applied by other methods, such as saturating, cascade, impregnating, wet or dry process roll or bar coating.

The coating compositions herein and applied by the curtain coating process are just that—they are coatings that adhere to and protect or provide other functionality to the surface of the substrate onto which they are applied. The coating aspect of cascade, saturating, impregnating roll or bar coating are fundamentally different from curtain coating techniques in that they are meant to penetrate into the substrate or are absorbed by the substrate to yield a higher coat weight.

The coating formulations described herein may be used to coat substrates such as paper, films, foils, paperboard, corrugated box stock, textiles and even metal. The coated substrates are suitable for packaging foods such as poultry, seafood, meats, bread, candy, ice cream, hot food items such as hamburgers, fruit, and vegetables. The coated substrates may also be used to package nonfood items such as appliances or industrial equipment. Further the coating is used to keep the substrate from being exposed to water or moisture, including humidity.

Compositions

Curtain coatings described herein comprise a polymer and an n-alpha olefin wax and optionally other components. A description of the curtain coating components that can be formulated and examples of formulations follow. However, it is recognized that those skilled in the art can formulate these and other components in various amounts to achieve other formulations encompassed by this disclosure.

Cascade and saturating compositions described herein are typically comprised of a polymer and an n-alpha olefin wax and optionally other components. A description of the cascade and saturating wax composition components that can be formulated and examples of formulations follow. However, it is recognized that those skilled in the art can formulate these and other components in various amounts to achieve other formulations encompassed by this disclosure.

Impregnating compositions described herein are typically applied at 100% n-alpha olefin wax and optionally other components. A description of the cascade and saturating wax composition components that can be formulated and examples of formulations follow. However, it is recognized that those skilled in the art can formulate these and other components in various amounts to achieve other formulations encompassed by this disclosure.

a. Wax Component.

The wax component in curtain coating wax will typically be present in the coating formulations in amount of from about 10 to 99%, or alternatively about 45 to 85%, or still further alternatively about 55 to 75% of the total coating composition by weight percent.

The wax component in cascade or saturating wax will typically be present in the coating formulations in amount of from about 10 to 100%, or alternatively about 65 to 100%, or still further alternatively about 95 to 100% of the total coating composition by weight percent.

The wax component in impregnating wax will typically be present in the coating formulations in amount of from about 50 to 100%, or alternatively about 75 to 100%, or still further alternatively about 95 to 100% of the total coating composition by weight percent.

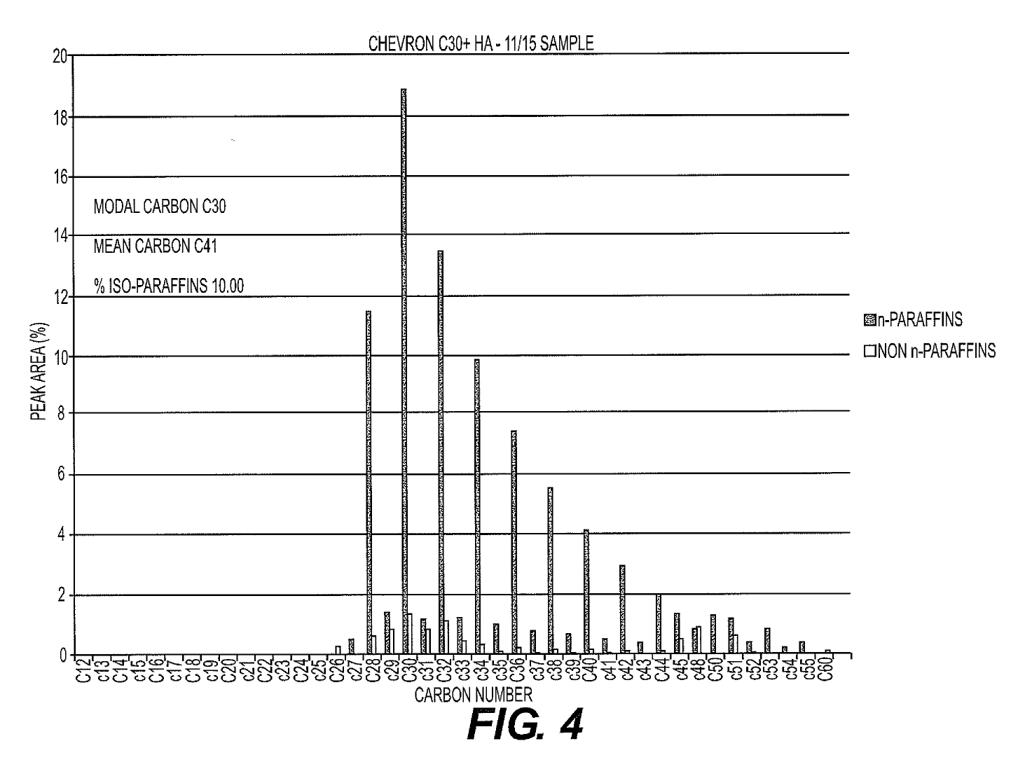

The wax component is formed of n-alpha olefin waxes. The n-alpha olefin waxes have a preferred melting point (ASTM D938) of about 150 to 160 degrees F., or alternatively about 120 to 175 degrees F. The n-alpha olefin waxes are preferred due to their structure which contains a terminal double bond, versus existing petroleum and other saturated aliphatic waxes. It is believed that the presence of the terminal double bond increases the compatibility between the wax and the other components in the formulation. Moreover, the n-alpha olefins of the present composition are linear olefins as opposed to other, branched aliphatic olefins. The size of the n-alpha olefin molecule may range from about 20 carbon atoms to about 70, or alternatively about 24 to 60 carbon atoms, or still further alternatively about 26 to 55 carbon atoms. Acceptable n-alpha olefin waxes are available commercially from Chevron Phillips Chemical Company such as C20-24, C26-28, C30+ and C30+HA. In particular C30+ and C30+HA compositions are believed useful (Gas Chromatograph attached as FIGS. 3 and 4). As is readily apparent from FIGS. 3 and 4, the n-alpha olefins that are commercially available are not a uniform composition of all single, identical atoms. However, persons of skill in the art recognize that the largest single amount of the n-alpha olefin is typically used to name that mix of molecules. The n-alpha olefins described herein use this known naming convention to describe those compositions.

While n-alpha olefins may replace paraffin wax components as described, it is still optional that a paraffin wax may be incorporated into the coating composition in amount of 50% or less, or alternatively 25% or less, or still further alternatively 10% or less, or still further alternatively about 1% or less of the coating composition, or as noted earlier herein, the composition may comprise essentially no paraffin wax. The inclusion of any paraffin wax is only contemplated to meet a functional need or perceived need in a particular coating application.

b. Polymer Component (Viscosity Modifier)

Any base polymer suitable for use in formulating hot melt adhesives, or wax based molten coatings, may be used herein. The curtain coatings will preferably comprise at least one ethylene polymer, and may comprise a blend of two or more polymers. The term ethylene polymer, as used herein, refers to homopolymers, copolymers and terpolymers of ethylene, including metallocene catalyzed polyolefin polymers. Preferred are copolymers of ethylene with one or more polar monomers, such as vinyl acetate or other vinyl esters of monocarboxylic acids. Ethylene vinyl acetate polymers (EVA) that may be used in the practice of the invention will generally have a MI (Melt Index) of about 2 grams/10 minutes to 400 grams/10 minutes, and having a vinyl acetate content of from about 16% to about 45% by weight, as well as blends thereof. Preferably the EVA will have a MI of about 2 to 10 and a VA % of about 24% to 30%. EVA copolymers are available from DuPont Chemical Co. under the tradename Elvax, from Exxon Mobil Chemical under the tradename Escorene, from AT Polymers under the tradename Ateva, and from USI under the tradename Evathene. Examples of EVA copolymers are: USI UE 632 and 659, and AT Polymers Ateva 2604. Examples of metallocene catalyzed polyolefin polymers are available under the brand names “Affinity” and “Engage”, registered trademarks of Dow Chemical.

This polymer component of a curtain coating formulation will usually be in an amount from about 1 to 50%, or alternatively about 5 to 30%, or still further alternatively about 10 to about 20% by weight of the total coating composition, with the actual amount determined by the target melt point and viscosity of a specific curtain coating formulation.

The polymer component of cascade, saturating, and impregnating and wet or dry process roll coating will usually be in the amount of 0 to 50% or alternatively about 0 to 25% or still further alternatively 0-15% by weight of the total coating composition, with the actual amount determined by a target melt point, viscosity, grease resistance and blocking point of a specific coating formulation.

c. Tackifying Component.

A tackifying component is commonly used in curtain coating formulations in order to increase the adhesion between the coating and the substrate. The tackifying component is usually present in the amount of zero to 30%, or alternatively about 1 to 20%, or still further about 2 to 10%, or in one example about 5% by weight of the coating composition. Useful tackifying resins may include any compatible resin or mixtures thereof such as natural and modified rosins, including for example, gum rosin, wood rosin, tall oil rosin, distilled rosin, hydrogenated rosin, dimerized rosin, resonates, and polymerized rosin; glycerol and pentaerythritol esters of natural and modified rosins, including the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; copolymers and terpolymers of natural terpenes, including styrene/terpene and alpha methyl styrene/terpene; polyterpene resins having a softening point of from about 70 C to 150 C; phenolic modified terpene resins and the hydrogenated derivatives thereof including, for example the resin product resulting from the condensation, in an acidic medium, of a bicylic terpene and a phenol; aliphatic petroleum hydrocarbon resins having a ring and ball softening point of from about 70 C to about 135 C.; aromatic petroleum hydrocarbon resin and the hydrogenated derivatives thereof; and alicyclic petroleum hydrocarbon resins and hydrogenated derivatives thereof. Also included are the cyclic or acyclic C5 resins aromatic modified acrylic or cyclic resins. Examples of commercially available rosins and rosin derivatives that could be used include Sylvalite RE 100L, Sylvalite RE 115, and Sylvares R 104 available from Arizona Chemical (Cray Valley); Dertocal 140 from DRT; Limed Rosin N0.1, GB-120 and Pencel C from Arakawa Chemical.

Other possible tackifiers are synthetic hydrocarbon resins, non-limiting examples include aliphatic olefin derived resins such as those available from Kraton Corporation under the RTM Wingtack and from Exxon Mobil Chemical under the RTM Escorez 1300 series. A common C5 tackifying resin in this class is a diene-olefin copolymer of piperylene and 2-methyl-2-butene having a softening point of about 95 degrees C. This resin is available commercially under the tradename Wingtack 95.

Further examples of a tackifier are aromatic hydrocarbon resins that are C9 aromatic/aliphatic olefin-derived and available from Cray Valley under the tradename Norsolene. Norsolene M1090 is a low molecular weight thermoplastic hydrocarbon polymer derived from alpha-pinene which has a ring and ball softening point of 95 to 105 degrees C. These C9 based hydrocarbon resins are particularly useful when synthesized with alpha-pinene, styrene, terpene, alpha-methystyrene, and/or vinyl toluene, and polymers, copolymers and terpolymers thereof, terpenes, terpene phenolics, modified terpenes, and combinations thereof. The increased aromatic structure of these resins produces more polar character in the resins that contributes towards the desired compatibility and performance of the curtain coating formulations.

d. Component to Enhance Coating Flexibility.

Microcrystalline waxes may be added to improve the flexibility of the finished coating on a substrate. Microcrystalline waxes are recovered from crude oil during the manufacturing of high viscosity lubricating oils. They characteristically are highly branched in chemical structure. The branching prevents them from forming large crystals in their solid form (thus the name) and results in a soft, flexible texture. Such waxes are available from IGI, Sonneborn, Calumet, IGI, and other suppliers of petroleum wax.

These microcrystalline waxes may comprise about zero to 50%, or alternatively about 5 to 30%, or still further alternatively about 8 to 20% by weight of the total coating composition.

e. Component to Increase Melting Point and or Hardness.

An additive component may be used to maximize the melting point and or the hardness of the coating composition. These additives include Fischer Tropsch wax, 50-110 C melt point or polyethylene wax. Such waxes are higher in melting point than the typical base petroleum and in the case with n-alpha olefin waxes used in the formulation. The high melting point additive increases the Drop Melting Point of the wax composition and in addition may provide increased scuff resistance. This additive component may be added in the amount of about 0.1 to 50%, or alternatively about 0.25 to 25%, or still further alternatively about 1 to 15% of the total coating composition.

### EXAMPLES

Several examples of a coating composition were formulated and tested for their performance. In practice, formulations may be customized for specific substrates and process conditions and end product performance requirements.

In one test, “Control” curtain coated boxes are coated corrugated boxes that are commercially manufactured and available boxes. These boxes were curtain coated with a typical paraffin wax based formulation common in the industry.

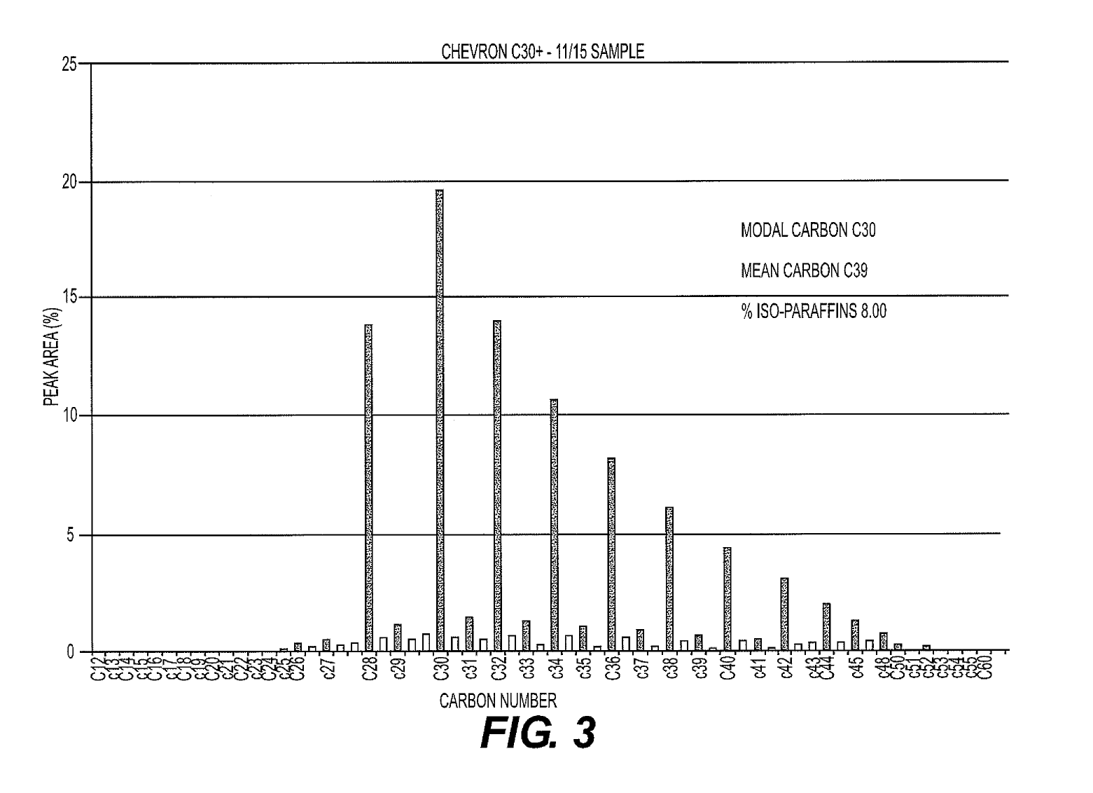

All of the tested boxes were composed of corrugated board, specifications 55#x36#x55# with fully impregnated medium. Lot A boxes were coated using an n-alpha olefin base formulation as described herein and exhibited superior performance over Control boxes in Edge Crush, Burst Strength and Flat Crush. Additionally Lot A boxes exhibited better gloss (subjective) while maintaining better slide angle performance. Slide Angle of the Control was 22° compared to Lot A slide angle at 24°. Also to be noted the Control and Lot A boxes were all run with the same wax pick up rates at 6.3 lbs./1000 sq. feet to 7 lbs. per 1000 sq. feet. Wax pick up rates are a function of the temperature of the formulation, application rates and belt speeds. Common Industry targets for wax pick up rates range between 5.5 lbs per 1000 square feet and 10 lbs. per 1000 square feet of corrugated box sheeting. The results of the following testing are illustrated in the bar graph shown as FIG. 2.

Performance Test Methods:

1. TAPPI 839 (ECT)

This method describes procedures for determining the edgewise compressive strength (ECT), perpendicular to the axis of the flutes, of a short column of single-, double-, or triple-wall corrugated fiberboard. The method includes procedures for cutting the test specimen, specimen support (waxed edges), and two procedures for applying the compressive force (constant strain rate, or constant load rate). Studies have shown that any combination of these procedures will yield the same test results with the stated precision. Edgewise compressive strength of corrugated fiberboard (short column test). Research has shown that the edgewise compressive strength of specimens with flutes vertical, in combination with the flexural stiffness of the combined board and box dimensions, relates to the top-to-bottom compressive strength of vertically fluted corrugated fiberboard shipping containers.

2. TAPPI 810 (BST)

The TAPPI T 810 Bursting strength method describes a procedure for measuring the bursting strength of single wall and double wall corrugated board within the range of 690 kPa (100 psi) to 4825 kPa (700 psi) employing an instrument which uses a disk shaped, molded diaphragm.

Bursting strength is the measure of the force required to puncture through (rupture) the corrugated board. It is often compared to edge crush strength (ECT: T 811, T 839), which is a measure of the compressive force a sample of the board can sustain in its vertical or loading direction before collapsing. While both are material properties of the corrugated board, depending on the papers used and how they are combined together, they measure different things.

3. TAPPI 808 (FCT)

The TAPPI T 808 Flat crush test is a measure of the resistance of the flutes in corrugated board to a crushing force applied perpendicular to the surface of the board under prescribed conditions. Flat crush is a measure of the flute rigidity of corrugated board. A high flat crush value indicates a combination of good flute formation and at least adequate strength medium.

Comparative Test Results:

A test was run to compare a coating composition described herein versus a conventional paraffin wax coating. Specifically, the Lot A boxes were coated with a composition that included 66% of n-alpha olefin wax and no paraffin wax. The control boxes were coated with a composition that included 69% paraffin wax and no n-alpha olefin wax. The balance of the compositions in each case included other similar components. Accordingly, the comparative tests were made based on the almost equal amounts of n-alpha olefin and paraffin wax coated onto the boxes.

As is readily apparent from the test results below in Tables 1 and 2, and visually in FIG. 2, the corrugated board with the n-alpha olefin based coating (Lot A) in Table 2 performs as well as or better than existing, conventional paraffin wax coated corrugated board (Control Boxes) Table 1.

TABLE 1
Control Boxes

| | | | | Std. | No. of |
|---|---|---|---|---|---|
| Property | Standard | | Mean | Dec. | Samples |
| ECT | TAPPI 839 | | 51.27 | 2.18 | 10 |
| | (1995) | | | | |
| BST | TAPPI 810 | Outside | 233.5 | 32.4 | 10 |
| (Psi) | (2011) | | | | |
| | | Inside | 238.5 | 29.7 | 10 |
| FCT | TAPPI 808 | | 41.46 | 1.54 | 10 |
| (psi) | (2013) | | | | |

TABLE 2
Lot A Boxes

| | | | | Std. | No. of |
|---|---|---|---|---|---|
| Property | Standard | | Mean | Dec. | Samples |
| ECT | TAPPI 839 | | 50.97 | 41 | 10 |
| (lb/in) | (1995) | | | | |
| BST | TAPPI 810 | Outside | 254.5 | 28.6 | 10 |
| (Psi) | (2011) | | | | |
| | | Inside | 243.5 | 20.6 | 10 |
| FCT | TAPPI 808 | | 48.18 | 1.64 | 10 |
| (Psi) | (2013 | | | | |

Other embodiments of the present invention will be apparent to those skilled in the art from consideration of the specification. It is intended that the specification and figures be considered as exemplary only, with a true scope and spirit of the invention being indicated by the claims.

That which is claimed is:

1. A wax coating composition for a corrugated sheet material, the coating composition comprising:
an n-alpha olefin wax having a melting point of from about 120 degrees F. to about 175 degrees F.;
an ethylene copolymer selected from the group consisting of an ethylene vinyl acetate copolymer and an ethylene n-butyl acrylate copolymer.

2. The composition as described in claim 1, further comprising another wax component selected from the group consisting of a microcrystalline wax, a Fisher Tropsch wax and a polyethylene wax.

3. The composition as described in claim 1, further comprising a polyethylene wax.

4. The composition as described in claim 1, further comprising a tackifier.

5. The composition as described in claim 1, wherein the composition comprises 50% or less paraffin wax.

6. The composition as described in claim 1, wherein the composition comprises essentially no paraffin wax.

7. The composition as described in claim 1, wherein the composition comprises 10-100% by weight of n-alpha olefin wax.

8. The composition as described in claim 1, wherein the composition comprises 50-100% by weight of n-alpha olefin wax.

9. The composition as described in claim 1, wherein the composition comprises 75-95% by weight of n-alpha olefin wax.

10. The composition as described in claim 1, wherein the n-alpha olefin wax has an average carbon atom content of 20 or greater.

11. The composition as described in claim 1, wherein the n-alpha olefin wax has an average carbon atom content of 26 or greater.

12. The composition as described in claim 1, wherein the n-alpha olefin wax is a C30+n-alpha olefin wax.

13. The composition as described in claim 1, wherein the n-alpha olefin wax has a melting point of about 160 degrees F.

14. The composition as described in claim 1, wherein the ethylene copolymer further comprises a metallocene catalyzed polyolefin polymer.
